(19) United States
(12) Patent Application Publication
(10) Pub. No.: US 2006/0222380 A1
(43) Pub. Date: Oct. 5, 2006

(54) Image forming apparatus

(75) Inventors: Yohichi Shimazawa, Nara (JP); Syoichiro Yoshiura, Nara (JP); Tsutomu Yoshimoto, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/395,383

(22) Filed: Mar. 30, 2006

(30) Foreign Application Priority Data
Apr. 5, 2005 (JP) 2005-108679

(51) Int. Cl. G03G 15/00

(52) U.S. Cl. 399/18

(57) ABSTRACT

Copy discouraging information which is used for prohibiting or discouraging copying of image information is formed so that it can be positively recognized by a copy machine. The copy discouraging information which is used for prohibiting or discouraging copying is printed so that the number, position and shape of the items of the copy discouraging information are made different depending upon the importance degree of the image information to be printed. If the image information has, for example, a relatively higher importance degree, a plurality of items of the copy discouraging information are printed in the inner sides and in the vicinity of four sides of recording paper. When someone tries to copy this recording paper by the copy machine, presence of the copy discouraging information can be immediately recognized in the copy machine regardless of the scanning direction.

### CROSS-NOTING PARAGRAPH

This non-provisional application claims priority under 35 U.S.C. §119(a) on Patent Application No. 2005-108679 filed in JAPAN on Apr. 5, 2005, the entire contents of which are hereby incorporated herein by reference.

### FIELD OF THE INVENTION

The present invention relates to an image forming apparatus and in particular to an image forming apparatus which is capable of appending copy discouraging information for prohibiting or discouraging the copying of image information when the image information is formed as an image.

### BACKGROUND OF THE INVENTION

In order to prevent unauthorized copying of an original printed document, techniques which append copy discouraging information such as background pattern when the original document is printed have been used.

For example, when image data is fed from an application running on a personal computer to a printer for printing out the image data from the printer, copy discouraging information which discourages the copying of the image to be printed is fed to the printer together with the above image data and is embedded in somewhere of the image to be printed for printing out.

When trying to copy the printed image in which the copy discouraging information is embedded, the copy machine which has detected the copy discouraging information will not output the copied image or output a copy sheet having thereon characters such as “Copy Prohibited”.

The above-mentioned copy discouraging information may be embedded in printed image in the way that it can not be recognized by the user or it can be recognized by the user.

In either case, the copy machine detects the presence of the copy discouraging information when the image information in which the copy discouraging information is embedded is copied and conducts predetermined processing such as prohibition of the copying per se or outputting a copied image having characters “Copy Prohibited” in response to a detection result.

In connection with the technique for prohibiting unauthorized copying, an image processing apparatus is disclosed in, for example, Japanese Laid-Open Patent Publication H11-215351. The image processing apparatus embeds a public key based upon an asymmetric public key scheme in a paper medium on copying in the way that the public key is hard to be visually recognized. The copied image may be visible. Even if someone tries to copy the copied material, it can not be copied without any secret key corresponding to the embedded public key.

An image processing apparatus in which unauthorized output is prevented by embedding the security level of an original document in the image data for the original document is disclosed in Japanese Laid-Open Patent Publication H11-355557. The security level for the original document may be appropriately set by the user.

In the above-mentioned system which embeds copy discouraging information in the printed image for printing out, the copy discouraging information is always embedded in the printed image irrespective of the importance degree of the image to be printed and the embedded image is printed out.

Such a system has a problem in that the copy discouraging information can not be positively detected in a copy machine if the printed document has graffiti or if foreign material or dirt on a part is adhered to the copy discouraging information.

There occurs another problem in that if a number of items of the copy discouraging information are appended at random on the printed image so that the copy machine can positively detect the presence of the copy discouraging information, the copy discouraging information will cause the printed image to bring discomfort.

### SUMMARY OF THE INVENTION

It is one object of the present invention to provide an image forming apparatus which is capable of positively detecting copy discouraging information used for prohibiting or restricting the copy of image information and in which discomfort which a printed image gives to a user is reduced as less as possible by changing the number, position and shape of the items of the copy discouraging information depending upon the importance degree of the image information.

It is another object of the present invention to provide an image forming apparatus which is capable of forming copy discouraging information used for prohibiting or discouraging the copying of image information on an image-formed material together with said image information when forming said image information, wherein any one or more of the number, position and shape of the items of said copy discouraging information to be formed on said image-formed material are made different depending upon the importance degree of said image information.

It is a further object of the present invention to provide an image forming apparatus which holds information on the number, position and shape of the items of said copy discouraging information depending upon the importance degree of said image information, receives importance degree information of said image information when forming said image and determines the number, position and shape of the items of said copy discouraging information to be formed on said image-formed material based upon the received importance degree information.

It is a further object of the present invention to provide an image forming apparatus in which said items of copy discouraging information are disposed on the inner side and in the vicinity of four sides of said image-formed material, which is a rectangle, for the image information having a relatively higher importance degree.

It is a further object of the present invention to provide an image forming apparatus in which said items of copy discouraging information are disposed on the inner side and in the vicinity of four corners of said image-formed material, which is a rectangle, for the image information having a relatively higher importance degree.

It is a further object of the present invention to provide an image forming apparatus which has a function of a copy machine and prohibits the copying of image information formed on image-formed material having said copy discouraging information by reading said copy discouraging information when said image information on said image-formed material is to be copied.

It is a further object of the present invention to provide an image forming apparatus which has a function of a copy machine and superposes alert information which alerts the user that copying of image information is prohibited or restricted on image information formed on image-formed material having said copy discouraging information to form a copied image by reading said copy discouraging information when said image information on said image-formed material is to be copied.

### BRIEF DESCRIPTION OF THE DRAWINGS

FIG. 1 is a view for explaining an exemplary configuration of a digital copy machine to which the present invention is applied;

FIG. 2 is a view for explaining functions which are provided in an image forming apparatus to which the present invention is applied;

FIG. 3 is a view for schematically explaining a processing for forming images with appending copy discouraging information to image information;

FIG. 4 is a view for explaining processing for adding and printing copy discouraging information which is conducted in the image forming apparatus;

FIG. 5 is a view showing an example of a screen for setting a printer driver;

FIG. 6 is a view showing an example of copy discouraging information;

FIG. 7 is a view showing an example of the arrangement of the copy discouraging information on recording paper;

FIG. 8 is a view showing another example of the arrangement of the copy discouraging information on recording paper; and

FIG. 9 is a view showing a further example of the arrangement of the copy discouraging information on recording paper.

### PREFERRED EMBODIMENTS OF THE INVENTION

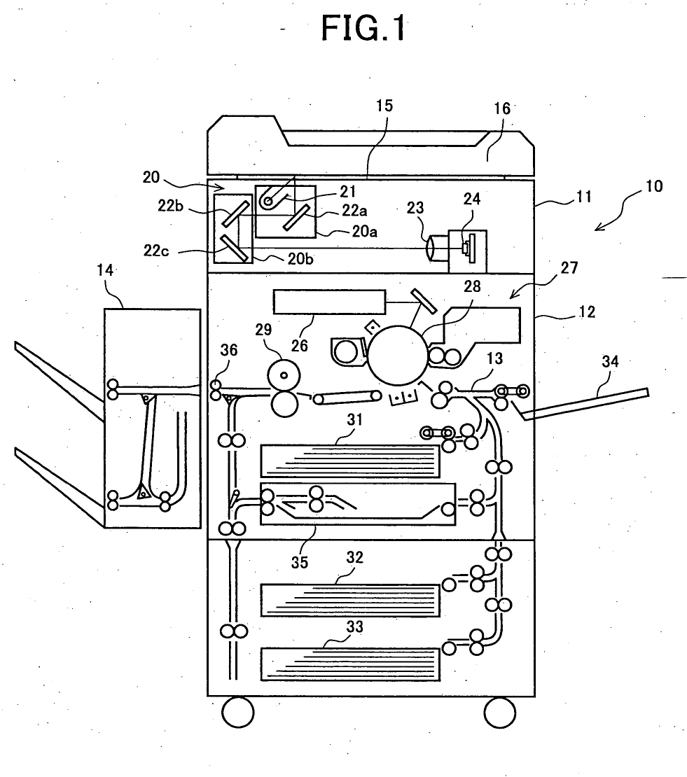

FIG. 1 is a schematic view for explaining an exemplary configuration of a digital copy machine to which an image forming apparatus of the present invention is applied. The image forming apparatus 10 is formed as a digital copy machine comprising a scanner portion 11 and a laser printer portion 12.

The scanner portion 11 comprises a base 15 made of transparent glass on which an original document is placed, a reversing automatic document feeder (RADF) 16 for automatically supplying and feeding documents to the base 15 and a scanner unit 20 for scanning the document on the base 15 to read the image on the document.

The RADF 16 comprises an original document tray (not shown). A plurality of sheets of original documents which are placed on the original document tray are automatically fed to the base 15 of the scanner unit 20 sheet by sheet by means of the RADF 16. The RADF 16 comprises a conveying path for single-sided documents, a conveying path for double-sided documents, means for switching between both conveying paths, and a group of sensors which detect the states of the documents passing through each part to manage them and a control portion. The RADF 16 is operated depending upon the selection of an operator to cause the scanner unit 20 to read one side or both sides of the original document.

The scanner unit 20 comprises a lamp reflector assembly 21 for exposing the surface of the original document to light, a photo-electric conversion element (CCD) 24, and first and second scanning units 20a, 20b and an optical lens 23 for guiding a light image reflected on the original document toward the CCD 24.

The light image which is reflected on the original document is reflected on a first reflection mirror 22a of the first scanning unit 20a and is then reflected on second and third mirrors 22b, 22c of the second scanning unit 20b and is imaged on the CCD 24 by means of the optical lens 23. The CCD 24 converts the reflected image from the original document, which is imaged by the optical lens 23, into an electrical image signal.

In the scanner portion 11, the images on the original documents are read by moving the scanner unit 20 along the lower side of the base 15 while the original documents to be read are successively placed on the base 15 by the synchronized operation between the RADF 16 and the scanner unit 20.

The first scanning unit 20a is moved from left to right along the base 15 at a constant speed V while the second scanning unit 20b is moved in the same direction at a speed of V/2 in parallel with the first scanning unit 20a.

This allows the image of the original document placed on the base 15 to be successively imaged on the CCD element 24 line by line for reading.

After the image data which is obtained by reading the original document image by the scanner unit 20 is subjected to various processing, it is stored in an image memory once. The image data in the image memory is then read in response to an instruction which directs the image forming apparatus 10 to output the data and is then transferred to the laser printer portion 12.

The laser printer portion 12 comprises a system for conveying sheets as recording material on which images are to be formed, a laser writing unit 26 and an electrophotographic processing portion 27 for forming images.

The laser writing unit 26 comprises a semiconductor laser light source which emits laser light in response to image data which is read by the scanner unit 20 and stored in the image memory or image data which is transferred from an external apparatus, a polygon mirror which deflects the laser light at an equal angular velocity and an f−θ lens which corrects the laser light which is deflected at an equal angular velocity so that it is deflected at an equal angular velocity on the photoconductive drum 28 which constitutes the electrophotographic processing portion 27.

The above-mentioned electrophotographic processing portion 27 comprises an electrostatic charger, developer, image transferring assembly, sheet paper separator, cleaner and neutralizer, which are arranged around the well-known photoconductive drum 28.

The sheet conveying system comprises a conveying portion 13 which conveys the sheets to the electrophotographic processing portion 27 in a transfer position in which the image transferring assembly is disposed, sheet paper cassettes 31, 32, 33 from which the sheet are fed to the conveying portion 13, a manual paper feeder 34 for appropriately feeding sheets of a required size, a fixing assembly 29 for fixing transferred toner image onto the sheet and re-supplying path 35 for supplying the sheet again so that image is formed on the side of the sheet opposite to the image fixed side thereof.

A post-processing device 14 which receives the image recorded sheet to apply a predetermined processing to the sheet is disposed downstream of the fixing assembly 29.

In the laser writing unit 26 and the electrophotographic processing portion 27, the electrostatic latent image of image data which is read from the image memory is formed on the peripheral surface of the photoconductive drum by making laser beams scan on the drum using the laser writing unit 26. The latent image is developed or visualized with toners by the developer. The developed toner image is electrostatically transferred to the sheet of paper which is conveyed from any one of multi paper feeding unit. The sheet of paper on which the image is formed is conveyed to the post-processing apparatus 14 via paper discharging rollers 36 from the fixing assembly 29.

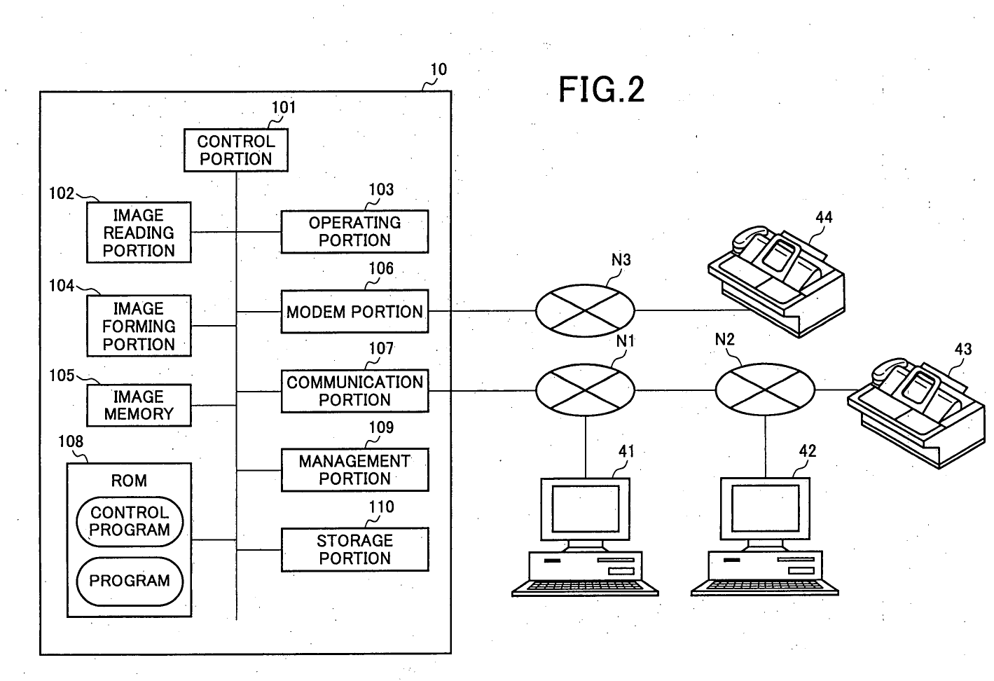

FIG. 2 is a schematic view showing an example of a multi-functional machine having functions of a copy machine, printer, facsimile and scanner and the like for explaining functions which are provided to an image forming apparatus to which the present invention is applied. The configuration shown in FIG. 2 is applicable to the digital copy machine shown in FIG. 1.

The image forming apparatus 10 comprises a control portion 101 which includes a CPU for performing operations and RAMs for storing temporal information in association with the operations. A ROM 108 which stores a control program for controlling the image forming apparatus 10 and a management portion 109 which is a memory for storing information for managing processing conducted by the image forming apparatus 10 are connected to the control portion 101. An image reading portion 102 which reads the images recorded on the recording paper to generate image data is connected to the control portion 101.

An image memory 105 which temporarily stores image data and an image forming portion 104 which forms image from the image data stored in the image memory 105 for recording it on the recording paper are connected to the control portion 101. After the image forming apparatus 10 stores the image data which is generated by the image reading portion 102 in the image memory 105 once, it can form an image in the image forming portion 104. In such a manner, the image forming apparatus 10 functions as a copy machine.

As shown in FIG. 2, a modem portion 106 which conducts facsimile communication is connected to the control portion 101 and the modem portion 106 is connected to a public telephone line network N3. The image forming apparatus 10 is capable of transmitting image data which is generated by the image reading portion 102 to other facsimile 44 via the public telephone line network N3 which is connected to the modem portion 106 by facsimile communication. The image forming apparatus 10 is also capable of receiving image data transmitted from the other facsimile 44 via the public telephone line network N3 at the modem portion 106 to form images at the image forming portion 104 from the received image data. In such a manner, the image forming apparatus 10 functions as a facsimile.

A communication portion (transceiving means) 107 which enables the image forming apparatus 10 to transmit/receive information to/from an external source is connected to the control portion 101. The communication portion 107 can be connected to a communication network N1 such as intra-LAN, to which one or more personal computers 41 can be connected. In a usual condition in which only the image forming apparatus 10 is operated, the communication portion 107 is connected to the communication network N1 for exchanging information with PC 41 via the communication network N1.

The image forming apparatus 10 is capable of transmitting image data which is generated by the image reading portion 102 from the communication portion 107 toward the PC 41. In such a manner, the image forming apparatus 10 functions as a scanner. Moreover, the image forming apparatus 10 is capable of receiving image data which is transmitted from the PC 41 at the communication portion 107 for forming images from the received image data at the image forming portion 104. In such a manner, the image forming apparatus 10 functions as a printer.

The communication network N1 is connected to a wide area communication network N2 such as the Internet. The communication portion 107 is capable of receiving image data from the information processing apparatus 42 or the other facsimile 43 connected to the wide area communication network N2 via the communication network N1 and the wide area communication network N2 by techniques such as transmitting an electronic mail accompanied with the image data. In such a manner, the image forming apparatus 10 functions as an Internet facsimile.

An operating portion 103 (instruction receiving means) which accepts the operation by the user is connected to the control portion 101. The operating portion 103 comprises display means such as liquid crystal display panel for displaying information necessary for operation and input means such as touch panel or ten-key pad from which information such as control instructions is input by the operation of the user. A storage portion 110 comprising a hard disk and optical disc is connected to the control portion 101. The storage portion 110 stores image data which is concerned with image processing of the image data generated by the image reading portion 102.

If the configuration of FIG. 2 is applied to the digital copy machine of FIG. 1, the scanner portion 11 and laser printer portion 12 correspond to the image reading portion 102 and the image forming portion 104, respectively. In other words, the image data of the original document image which is read by the scanner portion 11 of FIG. 1 is stored in the image memory 105 shown in FIG. 2. The image data is read from the image memory 105 in response to an output instruction to the digital copy machine and is fed to the laser printer portion 12, in which the image is formed on a sheet in accordance with the image data.

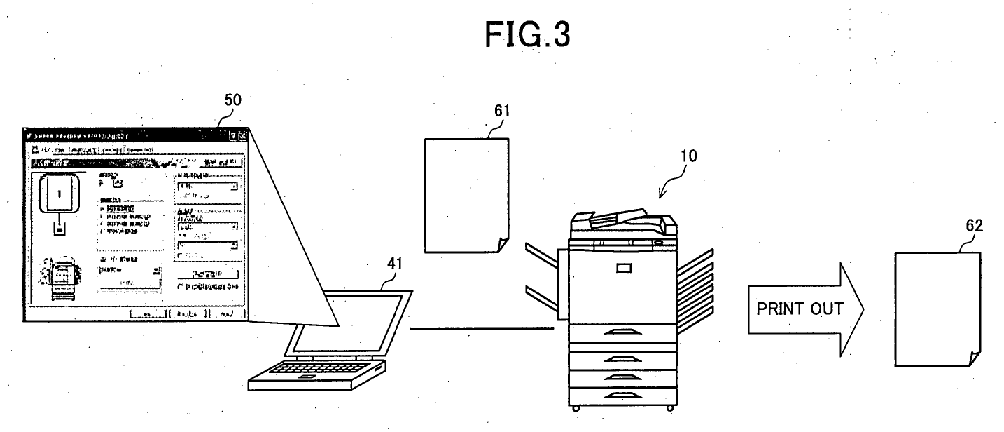

FIG. 3 is a schematic view for explaining processing in which the image is formed by appending copy discouraging information to image information. A processing for transferring image information 61 prepared by PC 41 to the image forming apparatus for printing out is illustrated.

When the user operates PC 41 to print out image information 61, setting which is related with appending copy discouraging information is conducted by using a screen 50 of a printer driver held in the PC 41 to instruct the image forming apparatus 10 to print out the image information. Setting of copy discouraging information is conducted so that the importance degree of the image information can be designated, for example, on the printer driver screen. The number, position and shape of the items of the copy discouraging information is set in accordance with the information on the importance degree. Examples of setting of the importance degree and specific pattern of the copy discouraging information will be explained below.

The image forming apparatus 10 receives image information 61 which is transferred from PC 41 and appends copy discouraging information on predetermined positions with the predetermined number and shape depending upon the importance degree of the image information 61 which is currently set and outputs printed images 62. It is assumed that the number, position and shape of the items of the copy discouraging information are preliminarily determined depending upon the importance degree of the image information. Any of the number, position and shape of the items of the copy discouraging information may be changed depending upon the importance degree of the image information. Alternatively, some of the number, position and shape of the items of the copy discouraging information may be changed depending upon the importance degree.

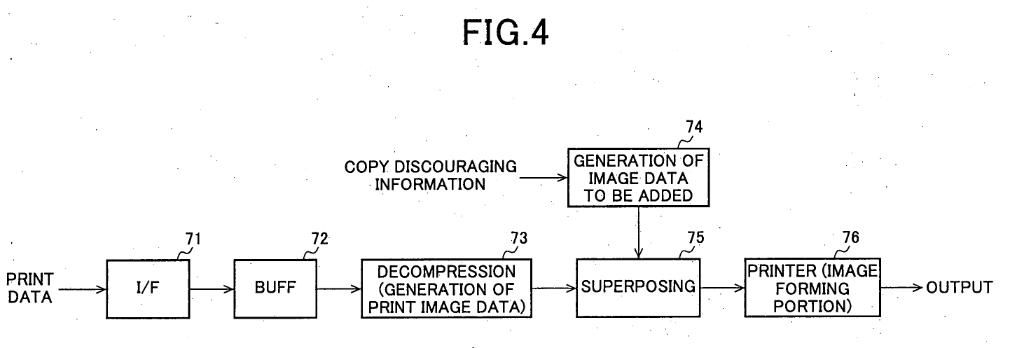

FIG. 4 is a view for explaining addition and printing processing of the copy discouraging information in the image forming apparatus 10. Image information to be printed (print data) is input to the image forming apparatus 10 from devices such as PC 41 via an I/F 71 of the image forming apparatus as mentioned above. The input print data is held in a buffer (Buff) 72 and is decompressed to generate print image data (73).

Meanwhile, additional image data is generated in accordance with the importance degree information which is designated for the image information to be printed using copy discouraging information to be appended to the print data (74). The generated additional image data is superposed on the above-mentioned print image data (75), and is fed to the printer (image forming portion) 76 and is printed on an image-formed material such as paper, which is then output.

In connection with the configuration of FIG. 2, the I/F 71 and Buff 72 correspond to the communication portion 107 and the image memory 105 of FIG. 2, respectively. Decompression of the print image data, generation of the additional image data and superposing of these data are conducted on the image memory 105 under control of the control portion 101 in FIG. 2. Printing of superposed print data is conducted on the image forming portion 104 of FIG. 2.

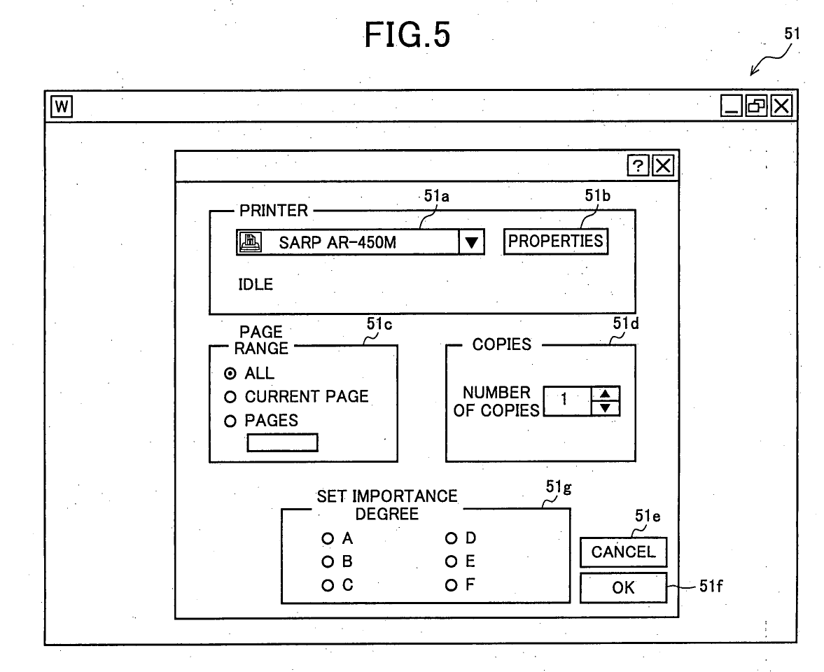

Now, an example of the setting screen for a printer driver to cause above-mentioned image forming apparatus to perform a printing operation will be described. FIG. 5 is a view showing an example of a setting screen of a printer driver.

When the user instructs the image forming apparatus to execute a printing output by using a PC and the like, a setting screen 51 of a printer driver is opened. In addition to printer name 51a, “Properties” 51b, “Page Range” 51c, “Copies” 51d, “Cancel” 51e and “OK” 51f which are conventionally displayed, “Set Importance Degree” 51g for setting the importance degree of the image information to be printed is provided on the setting screen 51.

The user designates the importance degree of the image information to be printed by using the above-mentioned “Set Importance Degree” 51g. Although the importance degree is divided into 6 ranks such as A through F, the ranking of the importance degree may be appropriately set.

The information which designates the importance degree is forwarded to the image forming apparatus together with image data (print data). The image forming apparatus generates copy discouraging information depending upon the importance degree and appends it to image information for printing out.

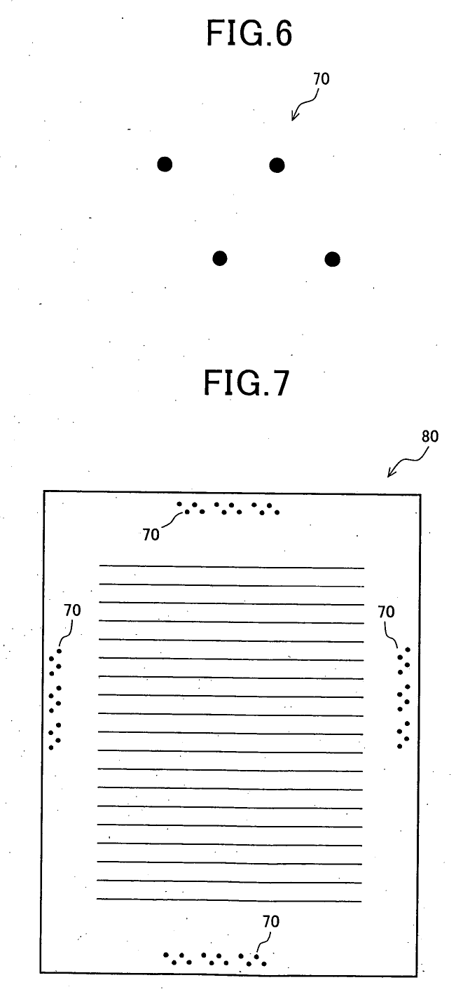

FIG. 6 is a view showing exemplary copy discouraging information. In the drawing, a reference numeral 70 denotes copy discouraging information. The copy discouraging information 70 may be formed as a pattern comprising a plurality of dots which are arranged as shown in FIG. 6. By detecting the copy discouraging information 70 by a copy machine, in the copy machine, copying per se is prohibited, or alert information which alerts the user that copying is prohibited or restricted is superposed on image information and copied images are output. The copy machine can be configured so that words “Copy Prohibited” are printed as the alert information or a word “Example” is printed as the alert information for the copy prohibited image, for example, a bank note.

By varying the size of the plurality of dots and arrangement, the copy discouraging information 70 can include a variety of information.

In the present embodiment, the image forming apparatus which appends the above-mentioned copy discouraging information is configured as a multi-functional machine having functions of the copy machine which conducts processing such as prohibiting of copying or appending alert information in accordance with copy discouraging information when image information with the copy discouraging information is copied. The image forming apparatus having a function of appending the copy discouraging information and a copy machine which performs processing such as copy prohibition or appending the alert information may be provided as separate machines.

FIG. 7 is a view showing exemplary arrangement of the copy discouraging information on recording paper. The copy discouraging information 70 which is shaped as shown in FIG. 6 is printed in the vicinity and in the inner side of each of four sides of the recording paper 80. This example is applied to image information having a relatively higher importance degree. Since the items of copy discouraging information 70 are disposed at the peripheries of the recording paper 80 in this case, presence of any of the items of the copy discouraging information 70 can be detected as soon as the scanning in any direction is conducted in the copy machine when the recording paper 80 is to be copied in the copy machine. Since three items of the copy discouraging information 70 are disposed on each of the sides of the recording paper 80, the copy discouraging information 70 can be positively detected in the copy machine even if a foreign material such as dust or dirt is adhered to any of the items of the copy discouraging information 70.

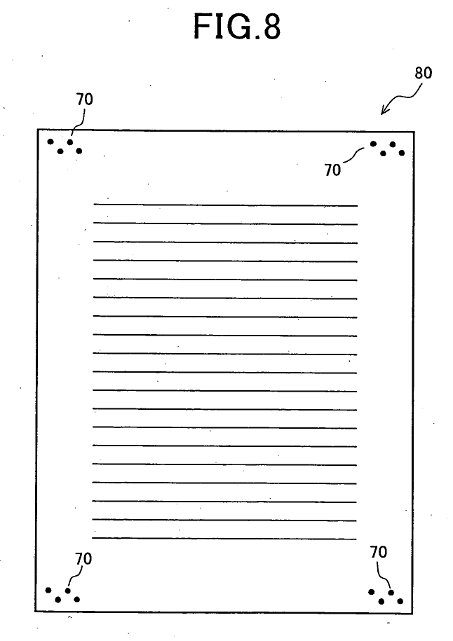

FIG. 8 is a view showing another example of arrangement of the copy discouraging information on recording paper. This example is applicable to the image information having a relatively higher importance degree. The items of copy discouraging information 70 are printed in the vicinity and in the inner side of each of four corners of the recording paper. Since the items of the copy discouraging information 70 are disposed at each of the four corners of the recording paper 80, presence of the copy discouraging information 70 can be detected as soon as scanning in any direction is conducted in the copy machine when the recording paper 80 is to be copied in the copy machine. Presence of the copy discouraging information can be immediately detected on scanning even if the recording paper 80 is placed obliquely with respect to the predetermined position of the base of the copy machine.

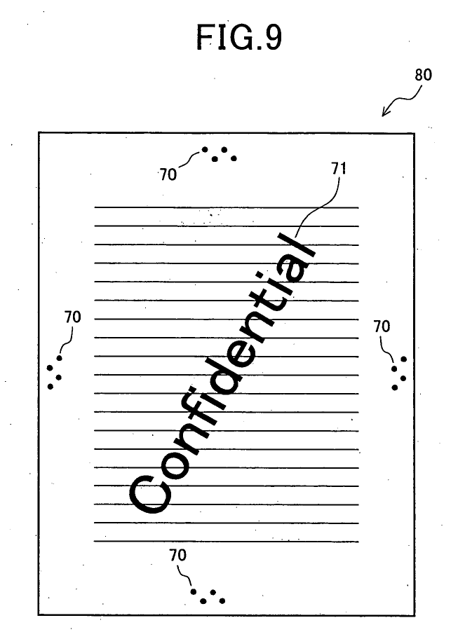

FIG. 9 is a view showing a further example of the arrangement of the copy discouraging information on recording paper. This example is applicable to the image information having a medium importance degree. As shown in FIG. 7, one item of the copy discouraging information is disposed in the vicinity and in the inner side of each of four sides of the recording paper 80 and another item of the copy discouraging information “Confidential” 71 having a user recognizable pattern is superposed on the image information of the original document for printing out.

The copy discouraging information which is applied in the present invention may be any pattern which can not be recognized by the user as the copy discouraging information. Alternatively or additionally, the copy discouraging information may be a pattern which enables the user to recognize that the copying of the image is prohibited or restricted like “Confidential”.

For example, for the image information having a low importance degree, arrangement of the above-mentioned copy discouraging information at any place of the printed image makes it possible to form printed image without bringing discomfort to the image information.

The present invention provides advantages as follows:

In accordance with the present invention, since the number and/or pattern of the items of the copy discouraging information and the position on which the copy discouraging information is appended may be changed depending upon the importance degree of the image information on an original document to be printed, copying of important or printed material can be positively prevented.

Since presence of copy discouraging information can be positively detected on reading of an original document for copying by increasing the number of the items of the copy discouraging information if the image information to be printed is important, a predetermined copying preventing processing, such as prohibition of copying per se or processing such as printing out of the copied image on which alert information for the user is superposed can be conducted.

If the image information to be copied has a lower importance degree, the printed image can be prevented from giving discomfort by decreasing the number of items of the copy discouraging information.

Appending copy discouraging information in the vicinity of four sides or corners recording sheet enables a copy machine to positively and quickly detect the presence of the copy discouraging information when the copy machine reads the printed image regardless of the reading direction for the image information in recording paper. An improvement in security of confidential documents can be achieved.

1. An image forming apparatus which is capable of forming copy discouraging information used for prohibiting or discouraging the copying of image information on an image-formed material together with said image information when forming said image information,
wherein any one or more of the number, position and shape of the items of said copy discouraging information to be formed on said image-formed material are made different depending upon the importance degree of said image information.

2. An image forming apparatus as defined in claim 1, wherein said image forming apparatus holds information on the number, position and shape of the items of said copy discouraging information depending upon the importance degree of said image information, receives importance degree information of said image information when forming said image information and determines the number, position and shape of the items of said copy discouraging information to be formed on said image-formed material based upon the received importance degree information.

3. An image forming apparatus as defined in claim 1 or 2, wherein said items of copy discouraging information are disposed on the inner side and in the vicinity of four sides of said image-formed material, which is a rectangle, for the image information having a relatively higher importance degree.

4. An image forming apparatus as defined in claim 1 or 2, wherein said items of copy discouraging information are disposed on the inner side and in the vicinity of four corners of said image-formed material, which is a rectangle, for the image information having a relatively higher importance degree.

5. An image forming apparatus as defined in claim 1 or 2, wherein said image forming apparatus has a function of a copy machine and prohibits the copying of image information formed on image-formed material having said copy discouraging information by reading said copy discouraging information when said image information on said image-formed material is to be copied.

6. An image forming apparatus as defined in claim 1 or 2, wherein said image forming apparatus has a function of a copy machine and superposes alert information which alerts the user that copying of image information is prohibited or restricted on image information formed on image-formed material having said copy discouraging information to form a copied image by reading said copy discouraging information when said image information on said image-formed material is to be copied.
